(19) United States
(12) Patent Application Publication
(10) Pub. No.: US 2026/0104081 A1
(43) Pub. Date: Apr. 16, 2026

(54) FLUID-FILLED VIBRATION DAMPING DEVICE

(71) Applicant: SUMITOMO RIKO COMPANY LIMITED, Komaki-shi (JP)

(72) Inventors: Hiroki KONDO, Komaki-shi (JP); Tomohiro KANAYA, Komaki-shi (JP)

(73) Assignee: SUMITOMO RIKO COMPANY LIMITED, Komaki-shi (JP)

(21) Appl. No.: 19/419,535

(22) Filed: Dec. 15, 2025

Related U.S. Application Data
(63) Continuation of application No. PCT/JP2024/033441, filed on Sep. 19, 2024.

(30) Foreign Application Priority Data
Sep. 25, 2023 (JP) 2023-161715

(51) Int. Cl. F16F 7/10

(52) U.S. Cl. CPC F16F 7/1034; F16F 2230/30

(57) ABSTRACT

A fluid-filled vibration damping device including a first attachment member, an annular second attachment member, a main rubber elastic body connecting the first and second attachment members, a fluid chamber filled with a non-compressible fluid, and a cup member in which the second attachment member is press-fitted via a press-fit rubber provided to an outer circumferential surface of the second attachment member. A sealing rubber is provided to a distal end surface of insertion of the second attachment member into the cup member to provide a sealing axially between the second attachment member and the cup member. An engaging rubber integrally formed with the press-fit rubber is provided to the second attachment member, and the second attachment member and the cup member are mutually positioned in an axial direction by engagement between the engaging rubber and the cup member.

### INCORPORATED BY REFERENCE

This application is a Continuation of International Application No. PCT/JP2024/033441 filed September 19, 2024, which claims priority under 35 U.S.C. §§119(a) and 365 of Japanese Patent Application No. 2023-161715 filed on September 25, 2023, the disclosures of which are expressly incorporated herein by reference in their entireties.

### BACKGROUND ART

### Technical Field

The present disclosure relates to a fluid-filled vibration damping device for use in an automotive engine mount and the like.

### Description of the Related Art

Conventionally, a fluid-filled vibration damping device, which utilizes a vibration damping effect based on flow action of a fluid sealed inside, has been used in an automotive engine mount and the like. As disclosed in U.S. Publication No. US 2017/0122398 A1, for example, the fluid-filled vibration damping device has a structure in which a first attachment member and a second attachment member are connected by a main rubber elastic body, and a fluid chamber filled with a non-compressible fluid is provided inside. When vibration is input to the fluid-filled vibration damping device, the vibration damping effect based on the flow action of the fluid and the like is exhibited.

### SUMMARY

Meanwhile, in the fluid-filled vibration damping device shown in US 2017/0122398 A1, the non-compressible fluid is sealed in the fluid chamber by a cup member being attached to the second attachment member. In US 2017/0122398 A1, a press-fit rubber is bonded to the outer circumferential surface of the second attachment member, and a sealing rubber protrudes from the distal end surface of press-fitting of the second attachment member. The second attachment member is rubber press-fitted into the cup member via the press-fit rubber, and the sealing rubber is compressed between the second attachment member and the cup member side, whereby a fluid-tight sealing is provided between the second attachment member and the cup member side.

However, due to compression of the sealing rubber in the rubber press-fit direction between the second attachment member and the cup member, spring back of the sealing rubber easily displaces the second attachment member in the direction of dislodgment from the cup member. This makes it difficult to properly hold the second attachment member and the cup member in position. Besides, when the second attachment member is rubber press-fitted into the cup member via the press-fit rubber, the second attachment member is fitted into the cup member with the press-fit rubber shear-deformed. Thus, the spring back of the press-fit rubber easily displaces the second attachment member in the direction of dislodgment from the cup member. As a result, there is a possibility that the sealing performance may become unstable due to variation in the compression allowance of the sealing rubber. Additionally, as in the case of US 2017/0122398 A1, when a bracket is mounted onto the second attachment member, there is a possibility that troubles may occur during mounting of the bracket.

It is therefore one object of the present disclosure to provide a fluid-filled vibration damping device of novel structure which is able to stably hold the second attachment member and the cup member in a suitable assembly position.

Hereinafter, preferred embodiments for grasping the present disclosure will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment provides a fluid-filled vibration damping device comprising: a first attachment member; a second attachment member having an annular shape; a main rubber elastic body connecting the first attachment member and the second attachment member; a fluid chamber filled with a non-compressible fluid; and a cup member in which the second attachment member is rubber press-fitted via a press-fit rubber provided to an outer circumferential surface of the second attachment member, wherein a sealing rubber is provided to a distal end surface of insertion of the second attachment member into the cup member, and the sealing rubber provides a sealing axially between the distal end surface of the second attachment member and the cup member, an engaging rubber integrally formed with the press-fit rubber is provided to the outer circumferential surface of the second attachment member, and the second attachment member and the cup member are mutually positioned in an axial direction by engagement between the engaging rubber and the cup member.

According to the fluid-filled vibration damping device structured following the present preferred embodiment, the second attachment member is rubber press-fitted in the cup member via the press-fit rubber. Thus, the sealing rubber provides a sealing axially between the second attachment member and the cup member, thereby reliably obtaining liquid tightness in the fluid chamber.

There is a possibility that the second attachment member and the cup member may, for example, be subjected to the force in the direction of dislodgment due to spring back of the press-fit rubber or the sealing rubber, which may cause the second attachment member and the cup member to be displaced in the direction of mutual dislodgment, thereby reducing the amount of compression of the sealing rubber to decrease the liquid tightness in the fluid chamber. Thus, by engaging the cup member with the engaging rubber integrally formed with the press-fit rubber, the relative displacement of the second attachment member and the cup member towards the side of dislodgment due to the spring back or the like can be prevented, thereby reliably obtaining the liquid tightness in the fluid chamber with stability.

The coupled portion between the second attachment member and the cup member is composed of a rubber press-fit structure via the press-fit rubber and an engagement structure by means of the engaging rubber. Thus, problems such as the noise due to rubbing of the coupled portion between the second attachment member and the cup member or the like are unlikely to occur.

A second preferred embodiment provides the fluid-filled vibration damping device according to the first preferred embodiment, wherein the engaging rubber comprises a rubber projection protruding radially outward with respect to the press-fit rubber, and the rubber projection is inserted in an axis-perpendicular direction into an engaging hole perforating a peripheral wall of the cup member, and the rubber projection is engaged with an inner circumferential surface of the engaging hole of the cup member in the axial direction.

According to the fluid-filled vibration damping device structured following the present preferred embodiment, the relative displacement of the second attachment member and the cup member in the direction of dislodgment can be limited by a simple structure with the rubber projection protruding radially outward and the engaging hole perforating the peripheral wall of the cup member.

A third preferred embodiment provides the fluid-filled vibration damping device according to the second preferred embodiment, wherein the second attachment member has a flat annular shape with a long side and a short side when viewed in the axial direction, and the rubber projection is provided to a long-side portion of the second attachment member.

According to the fluid-filled vibration damping device structured following the present preferred embodiment, the engaging hole is formed in the long-side portion of the peripheral wall of the cup member, which has a tubular shape corresponding to the outer shape of the second attachment member. This reduces resistance when inserting the rubber projection into the engaging hole, thereby facilitating assembly of the second attachment member and the cup member.

A fourth preferred embodiment provides the fluid-filled vibration damping device according to the second or third preferred embodiment, wherein the second attachment member has a flat annular shape with a long side and a short side when viewed in the axial direction, and the rubber projection is provided to a corner of the second attachment member.

According to the fluid-filled vibration damping device structured following the present preferred embodiment, the engaging hole is provided to the corner where the deformation rigidity of the cup member is relatively high. Thus, the rubber projection is unlikely to become dislodged from the engaging hole, and the positioning of the second attachment member and the cup member by engagement between the rubber projection and the engaging hole is more stable and easily held.

A fifth preferred embodiment provides the fluid-filled vibration damping device according to any one of the first through fourth preferred embodiments, wherein the cup member includes a hook protruding from a peripheral wall toward a proximal end side of insertion of the second attachment member, and the hook is engaged with the engaging rubber in the axial direction.

According to the fluid-filled vibration damping device structured following the present preferred embodiment, there is no need to provide a hole in the peripheral wall of the cup member for engaging with the engaging rubber, and a large area for the rubber press-fitting can be ensured. Besides, the second attachment member and the cup member are positioned by the hook protruding from the cup member being engaged with the engaging rubber provided on the proximal end side of press-fitting with respect to the press-fit rubber. Thus, the liquid tightness in the fluid chamber is reliably obtained by the sealing rubber.

A sixth preferred embodiment provides the fluid-filled vibration damping device according to the fifth preferred embodiment, wherein the cup member has a flat annular shape with a long side and a short side when viewed in the axial direction, and the hook is provided to a short-side portion of the cup member.

According to the fluid-filled vibration damping device structured following the present preferred embodiment, deformation is suppressed in the short-side portion of the cup member where the hook is provided. Thus, the engaged state between the engaging rubber and the hook is unlikely to be released, and the sealing performance can be obtained more stably.

A seventh preferred embodiment provides the fluid-filled vibration damping device according to any one of the first through sixth preferred embodiments, wherein the engaging rubber protrudes radially outward with respect to the press-fit rubber, and in a direction of insertion of the second attachment member, the engaging rubber is located on a proximal end side of the insertion with respect to a center of the press-fit rubber.

According to the fluid-filled vibration damping device structured following the present preferred embodiment, the positioning of the second attachment member and the cup member can be achieved by engagement between the engaging rubber and the cup member side while reliably obtaining the area of the rubber press-fit portion of the second attachment member into the cup member.

According to the present disclosure, it is possible to stably hold the second attachment member and the cup member in a suitable assembly position in the fluid-filled vibration damping device.

### BRIEF DESCRIPTION OF THE DRAWINGS

The foregoing and/or other objects, features and advantages of the disclosure will become more apparent from the following description of practical embodiments with reference to the accompanying drawings in which like reference numerals designate like elements and wherein:

FIG. 1 is a perspective view of an engine mount according to a first practical embodiment of the present disclosure;

FIG. 2 is a vertical cross sectional view of the engine mount shown in FIG. 1, corresponding to a cross section taken along line 2-2 of FIG. 3;

FIG. 3 is a cross sectional view taken along line 3-3 of FIG. 2;

FIG. 4 is a cross sectional view taken along line 4-4 of FIG. 2;

FIG. 5 is a cross sectional view taken along line 5-5 of FIG. 2;

FIG. 6 is a perspective view of a mount main body constituting the engine mount shown in FIG. 1;

FIG. 7 is a right side view of the mount main body shown in FIG. 6;

FIG. 8 is a cross sectional view of the mount main body shown in FIG. 6, corresponding to a cross section taken along line 8-8 of FIG. 9;

FIG. 9 is a cross sectional view taken along line 9-9 of FIG. 7;

FIG. 10 is a cross sectional view taken along line 10-10 of FIG. 7;

FIG. 11 is a perspective view of a cup member constituting the engine mount shown in FIG. 1;

FIG. 12 is a cross sectional view of the cup member shown in FIG. 11, corresponding to a cross section taken along line 12-12 of FIG. 13;

FIG. 13 is a cross sectional view taken along line 13-13 of FIG. 12;

FIG. 14 is a perspective view of the engine mount shown in FIG. 1 with a bracket mounted;

FIG. 15 is a vertical cross sectional view of the engine mount with the bracket mounted as shown in FIG. 14, corresponding to a cross section taken along line 15-15 of FIG. 16;

FIG. 16 is a cross sectional view taken along line 16-16 of FIG. 15;

FIG. 17 is a cross sectional view taken along line 17-17 of FIG. 15;

FIG. 18 is a cross sectional view taken along line 18-18 of FIG. 15;

FIG. 19 is a cross sectional view taken along line 19-19 of FIG. 18;

FIG. 20 is a perspective view of an engine mount according to a second practical embodiment of the present disclosure;

FIG. 21 is a transverse cross sectional view of the engine mount shown in FIG. 20;

FIG. 22 is a vertical cross sectional view of an engine mount according to a third practical embodiment of the present disclosure; and

FIG. 23 is a vertical cross sectional view of the engine mount shown in FIG. 22 with a bracket mounted.

### DETAILED DESCRIPTION

Hereinafter, practical embodiments of the present disclosure will be described in reference to the drawings.

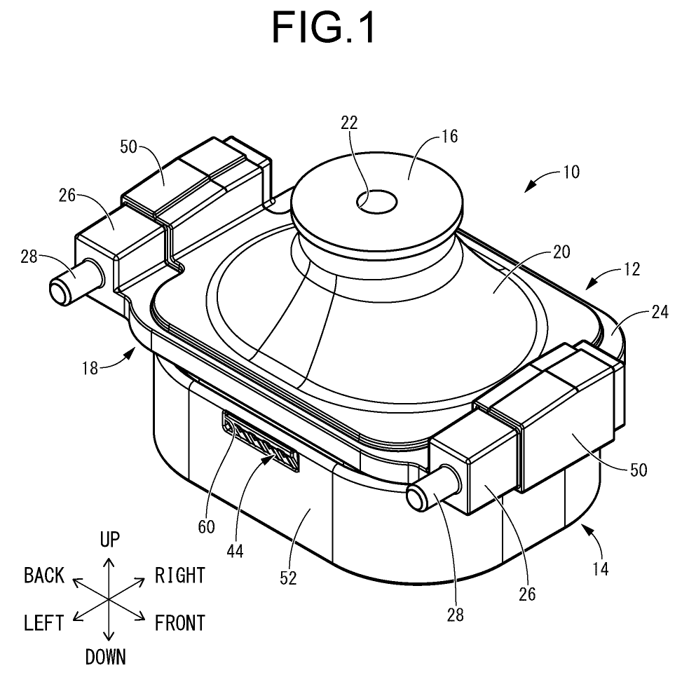

FIGS. 1 to 5 depict an automotive engine mount 10 as a first practical

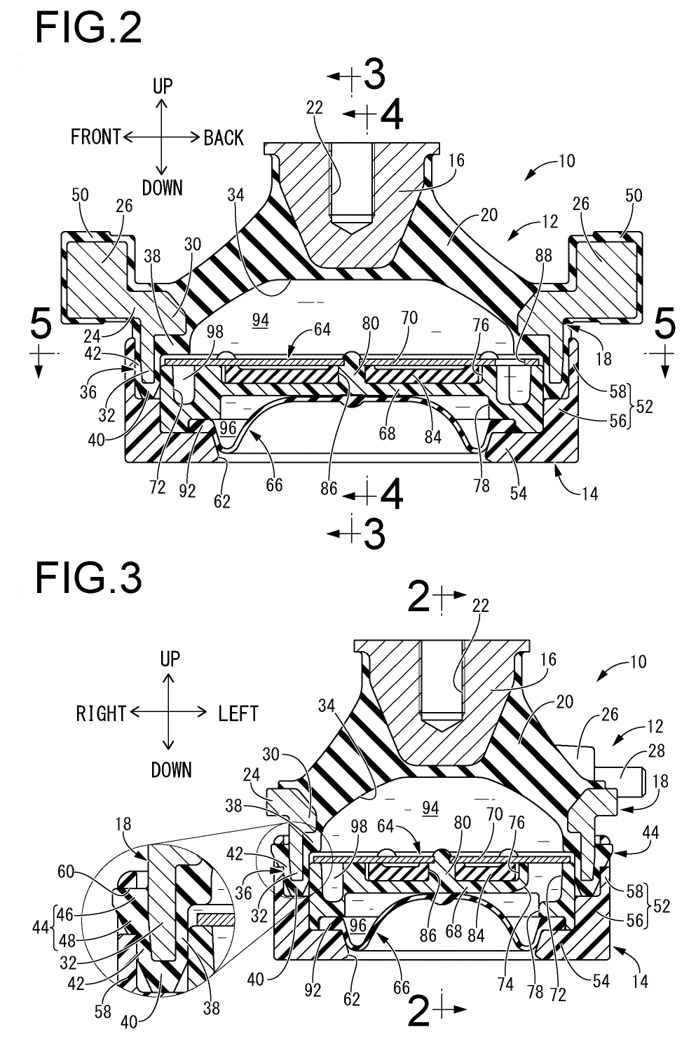

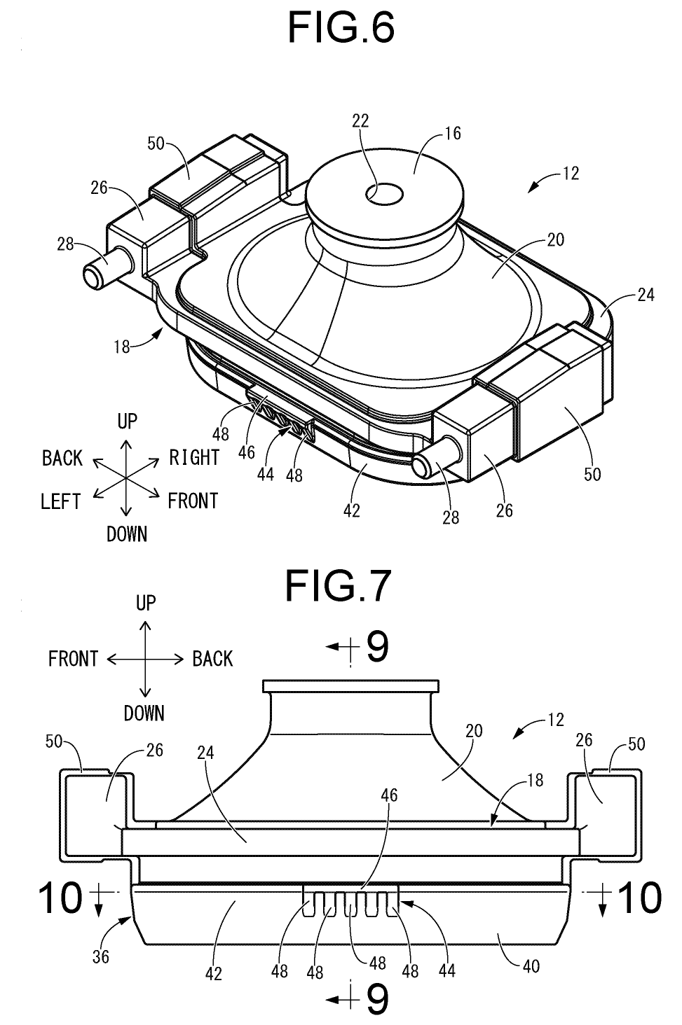

embodiment of a fluid-filled vibration damping device constructed according to the present disclosure. The engine mount 10 includes a mount main body 12 and a cup member 14 attached to the mount main body 12. As shown in FIGS. 6 to 10, the mount main body 12 has a structure in which a first attachment member 16 and a second attachment member 18 are connected by a main rubber elastic body 20. In the following description, as a general rule, the vertical direction refers to the vertical direction in FIG. 2 coinciding with the mount center axis direction, which is the main load input direction. Besides, the front-back direction refers to the left-right direction in FIG. 2 and the left-right direction refers to the left-right direction in FIG. 3.

The first attachment member 16 has a cylindrical shape or a shape of an inverted frustum of a circular cone that decreases in diameter downward overall, and includes a screw hole 22 opening on its upper surface. The first attachment member 16 is a high rigidity component and may be made of fiber-reinforced synthetic resin or the like, for example, but is preferably made of metal such as aluminum alloy.

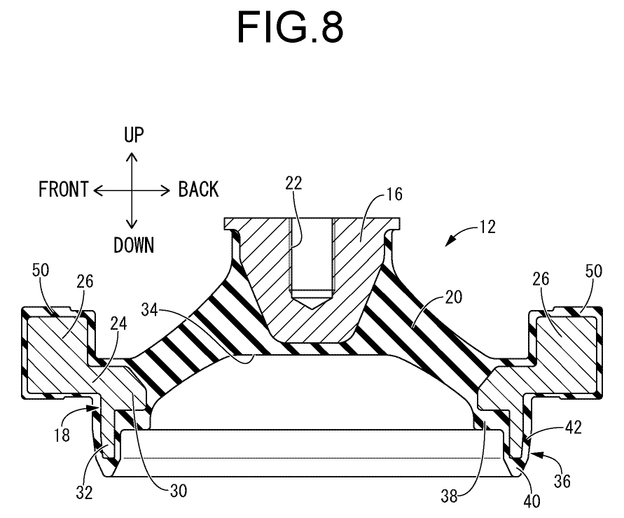

As shown in FIGS. 8 to 10, the second attachment member 18 has an approximately rounded quadrangular tube shape whose corners are curved arcuately, and has a flat shape with a pair of long sides extending in the front-back direction and a pair of short sides extending in the left-right direction when viewed in the axial direction. The second attachment member 18 includes flange-shaped parts 24 protruding radially outward from its upper end, and fitting parts 26 extending straightly in the left-right direction are integrally formed on the respective front and back outer sides of the flange-shaped parts 24 provided to the pair of short sides. Each fitting part 26 has an approximately quadrangular pillar shape, and its vertical width dimension gradually decreases leftward. A cylindrical swaging pin 28 protruding leftward is integrally formed with the left end surface of the fitting part 26. The second attachment member 18 is a high rigidity component and, like the first attachment member 16, is preferably made of fiber-reinforced synthetic resin, metal, or the like. Besides, the second attachment member 18 has a larger diameter than that of the first attachment member 16.

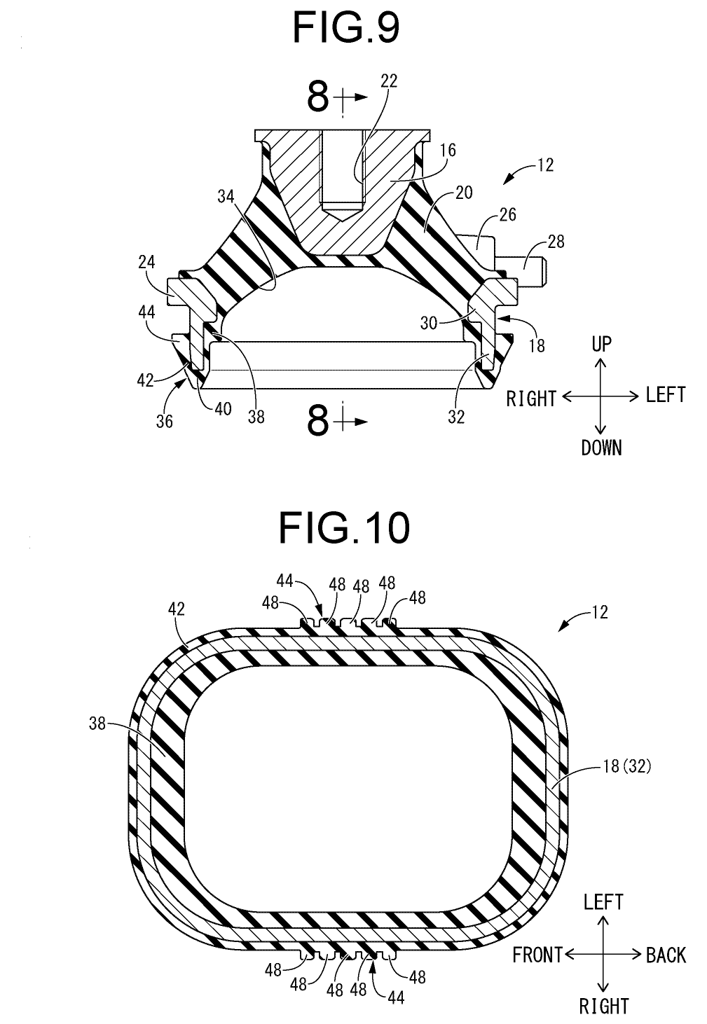

As shown in FIGS. 8 and 9, the first attachment member 16 is arranged above the second attachment member 18 on approximately the same center axis, and the main rubber elastic body 20 is arranged between the first attachment member 16 and the second attachment member 18. The main rubber elastic body 20 has an approximately frustum shape whose outer circumferential surface has a tapered shape that increases in diameter downward. The first attachment member 16 is bonded by vulcanization in an inserted state to the upper end of the main rubber elastic body 20, which is the small-diameter side end, while the second attachment member 18 is overlapped with and bonded by vulcanization to the outer circumferential surface of the lower end of the main rubber elastic body 20, which is the large-diameter side end. Thus, the main rubber elastic body 20 takes the form of an integrally vulcanization molded component incorporating the first attachment member 16 and the second attachment member 18, and the mount main body 12 of the present practical embodiment is composed of the said integrally vulcanization molded component of the main rubber elastic body 20. The upper part of the second attachment member 18, which is bonded to the main rubber elastic body 20, is integrally provided with a bonding part 30 protruding radially inward, and the inner diameter dimension of the upper part provided with the bonding part 30 is smaller than that of the lower part (a press-fit tube part 32) that is off the bonding part 30. The inner circumferential surface of the bonding part 30 is a tapered surface that decreases in diameter downward.

The main rubber elastic body 20 includes a recess 34 opening downward. The recess 34 has an inverted, approximately bowl shape that decreases in diameter toward the upper wall, and is provided on the radially inner side of the bonding part 30 of the second attachment member 18. Due to the formation of the recess 34, the portion of the main rubber elastic body 20, which connects the first attachment member 16 and the second attachment member 18, has a tapered shape in which both the inner diameter and the outer diameter increase downward.

The press-fit tube part 32, which is the lower part of the second attachment member 18, is covered with a rubber layer 36 that is integrally formed with the main rubber elastic body 20. The rubber layer 36 covers the entire inner circumferential surface and the lower part of the outer circumferential surface of the press-fit tube part 32. An inner circumferential rubber 38 of the rubber layer 36, which covers the inner circumferential surface of the press-fit tube part 32, is thicker at its upper part than at its lower part. The outer peripheral portion of the thick-walled upper part of the inner circumferential rubber 38 is bonded to the lower surface of the bonding part 30, while the radially inner end of the upper part of the inner circumferential rubber 38 is integrally continuous with the main rubber elastic body 20.

The portion of the rubber layer 36, which covers the lower surface of the press-fit tube part 32, comprises a sealing rubber 40. The sealing rubber 40 is formed continuously about the entire circumference with a tapered cross-sectional shape that narrows downward in the radial direction. The portion of the sealing rubber 40 having the maximum protrusion height is arranged at the location that overlaps the lower surface of the press-fit tube part 32 as viewed in the vertical direction. The maximum thickness (the protrusion height) of the sealing rubber 40 is greater than the thicknesses of the inner circumferential rubber 38 and a press-fit rubber 42 described later.

The portion of the rubber layer 36, which covers the outer circumferential surface of the press-fit tube part 32, comprises the press-fit rubber 42. The press-fit rubber 42 is formed so as to cover the outer circumferential surface of the lower part of the press-fit tube part 32. The outer circumferential surface of the lower part of the press-fit rubber 42 has a tapered shape that decreases in diameter downward.

A pair of rubber projections 44, 44 serving as engaging rubbers are integrally formed with the press-fit rubber 42. As shown in FIGS. 6, 7, 9, and 10, each rubber projection 44 protrudes radially outward from the rubber layer 36 (the press-fit rubber 42) bonded to the long-side portion of the second attachment member 18, and its protruding distal end is located radially outer side with respect to the press-fit rubber 42 in the short-side direction of the second attachment member 18. It is desirable that the rubber projection 44 be located above the vertical center of the press-fit rubber 42 (on the proximal end side of insertion of the second attachment member 18 into the cup member 14, as described later). In the present practical embodiment, the rubber projection 44 is provided at the upper end of the press-fit rubber 42.

Described more specifically, the rubber projection 44 integrally comprises a coupling part 46 protruding outward in the left-right direction with an approximately constant protrusion height dimension while extending in the front-back direction, and a plurality of rib-shaped parts 48 provided below the coupling part 46. The coupling part 46 has an approximately rectangular plate shape overall, and is longer in the front-back direction than in the left-right direction, which is the direction of protrusion. The coupling part 46 protrudes radially outward from the upper end of the press-fit rubber 42 bonded to the outer circumferential surface of the press-fit tube part 32, and the second attachment member 18 is exposed above the coupling part 46.

Each rib-shaped part 48 protrudes outward in the left-right direction below the coupling part 46. The rib-shaped part 48 extends in the vertical direction, and is integrally connected at its upper end to the coupling part 46. The protrusion height dimension of the rib-shaped part 48 outward in the left-right direction increases upward, and the rib-shaped part 48 has an approximately right-angled triangular shape when viewed in the front-back direction. Each rubber projection 44 includes a plurality of rib-shaped parts 48, which are mutually spaced apart in the front-back direction. In the present practical embodiment, the five rib-shaped parts 48, 48, 48, 48, 48 are arrange at equal intervals in the front-back direction, and the outer surfaces in the front-back direction of the rib-shaped parts 48, 48 located at the opposite ends in the front-back direction are approximately flush with the end surfaces in the front-back direction of the coupling part 46.

Besides, as shown in FIGS. 6 to 8, a fitting rubber 50 integrally formed with the main rubber elastic body 20 is bonded to each fitting part 26 of the second attachment member 18. The fitting rubber 50 is provided to a part of the fitting part 26 in the left-right direction, and covers the front and back surfaces and the upper and lower surfaces of the fitting part 26. In the present practical embodiment, a step is provided in the portion of the fitting rubber 50 that covers each of the upper and lower surfaces of fitting part 26, and the fitting rubber 50 is thicker on the outside of the step than on the inside in the front-back direction. Regarding the fitting rubber 50 in the present practical embodiment, the vertical outer dimension of the right-side portion is approximately constant in the left-right direction, while the vertical outer dimension of the left-side portion gradually decreases leftward, and the fitting rubber 50 is thick-walled in the middle in the left-right direction.

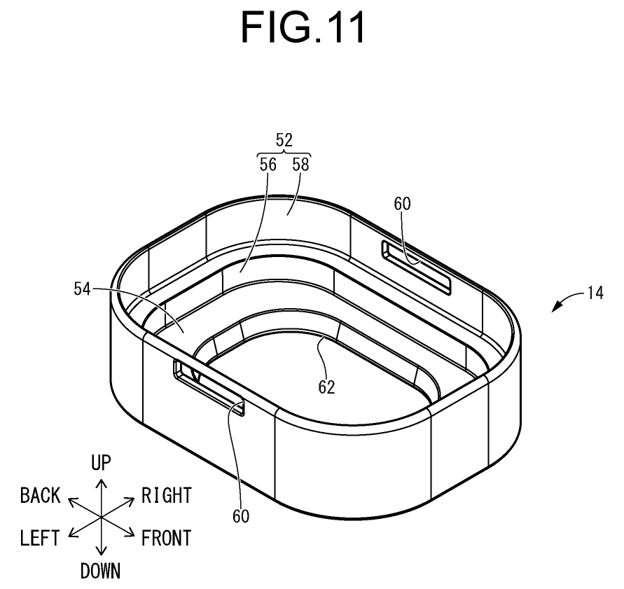

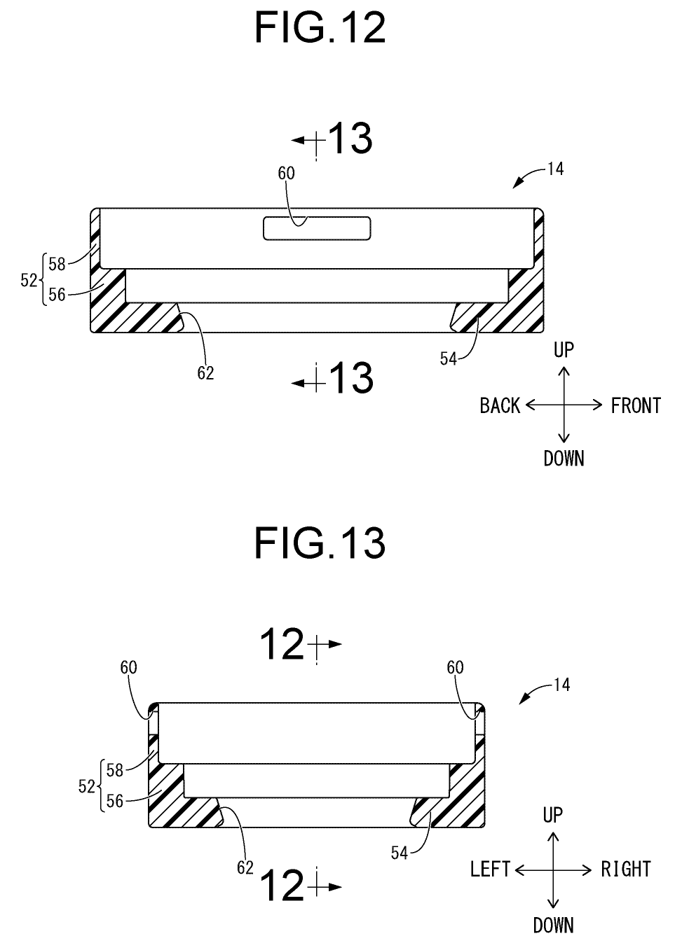

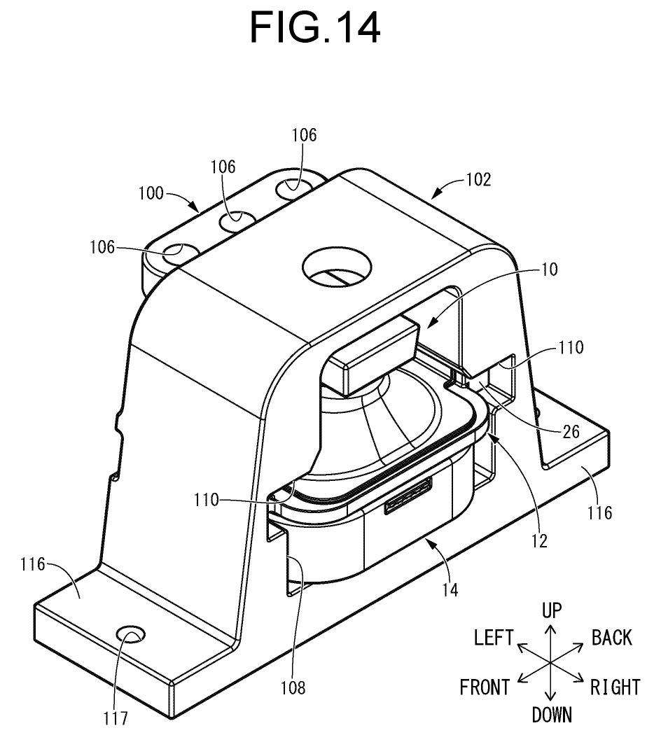

As shown in FIGS. 11 to 13, the cup member 14 integrally comprises a peripheral wall 52, which has an approximately rounded rectangular tube shape corresponding to the second attachment member 18, and a bottom wall 54, which is provided so as to close the lower opening of the peripheral wall 52.

The peripheral wall 52 integrally comprises a partition insertion part 56 protruding upward from the outer peripheral end of the bottom wall 54, and a base press-fit part 58 protruding upward from the outer peripheral end of the partition insertion part 56. The base press-fit part 58 is thinner than the partition insertion part 56, and preferably has a radial thickness dimension that is not greater than half that of the partition insertion part 56.

The base press-fit part 58 of the peripheral wall 52 includes a pair of engaging holes 60, 60 that perforate its long-side portions in the left-right direction. Each engaging hole 60 is a hole with an approximately rectangular cross section corresponding to the rubber projection 44 of the mount main body 12, and is provided above the vertical center of the base press-fit part 58. The engaging hole 60 has a width dimension in the front-back direction not smaller than that of the rubber projection 44, and has a vertical height dimension smaller than the height dimension in the front-back direction of the rubber projection 44.

The bottom wall 54 is perforated by a passage hole 62 in the vertical direction. By forming this passage hole 62, the bottom wall 54 has an inner flanged shape protruding radially inward at the lower end of the peripheral wall 52.

The cup member 14 is a rigid member, but is preferably allowed to undergo flexural deformation to some extent in the radial direction especially at the base press-fit part 58. The cup member 14 may be made of metal, but is suitably made of rigid synthetic resin (including fiber-reinforced synthetic resin).

As shown in FIGS. 2 and 5, the press-fit tube part 32 of the second attachment member 18 of the mount main body 12 is inserted into the base press-fit part 58 of the peripheral wall 52 of the cup member 14 in the axial direction. The press-fit rubber 42 of the rubber layer 36 is compressed between the outer circumferential surface of the press-fit tube part 32 of the second attachment member 18 and the inner circumferential surface of the base press-fit part 58 of the cup member 14. In this way, the second attachment member 18 and the cup member 14 are mutually positioned by the press-fit tube part 32 of the second attachment member 18 being rubber press-fitted into the base press-fit part 58 of the cup member 14 via the press-fit rubber 42.

The sealing rubber 40 and the press-fit rubber 42, which are parts of the rubber layer 36, provide a liquid-tight sealing between the press-fit tube part 32 of the second attachment member 18 and the peripheral wall 52 of the cup member 14. Specifically, the sealing rubber 40 covering the lower surface, which is the distal end surface of insertion of the second attachment member 18 into the cup member 14, is compressed between the vertically opposed surfaces of the lower surface of the press-fit tube part 32 of the second attachment member 18 and the upper surface of the partition insertion part 56 of the cup member 14, thereby providing a liquid-tight sealing between the vertically opposed surfaces of the press-fit tube part 32 and the partition insertion part 56. Besides, the press-fit rubber 42 is compressed between the radially opposed surfaces of the outer circumferential surface of the press-fit tube part 32 and the inner circumferential surface of the base press-fit part 58, thereby providing a liquid-tight sealing between the radially opposed surfaces of the press-fit tube part 32 and the base press-fit part 58.

As shown in FIGS. 3 to 5, the rubber projection 44 protruding from the press-fit rubber 42 is inserted in the axis-perpendicular direction into the engaging hole 60 formed through the peripheral wall 52 of the cup member 14. The upper surface of the rubber projection 44 is overlapped with the inner surface of the engaging hole 60 in the vertical direction, so that the rubber projection 44 and the inner surface of the engaging hole 60 are engaged in the vertical direction. With this configuration, the upward displacement of the mount main body 12 relative to the cup member 14 is limited, and separation of the mount main body 12 and the cup member 14 is prevented, thereby holding the second attachment member 18 and the cup member 14 in position with respect to each other in the vertical direction. As a result, a rubber press-fit state of the press-fit tube part 32 into the base press-fit part 58 via the press-fit rubber 42 is stably maintained, so that the rubber layer 36 (the sealing rubber 40 and the press-fit rubber 42) retains a stable sealing between the second attachment member 18 and the cup member 14.

The sealing rubber 40 covering the lower surface of the press-fit tube part 32 of the second attachment member 18 is pressed against the upper surface of the partition insertion part 56 of the cup member 14, and the sealing rubber 40 is compressed in the vertical direction between the press-fit tube part 32 and the partition insertion part 56. Thus, the dislodging force due to the elasticity of the sealing rubber 40 acts between the second attachment member 18 and the cup member 14. In the engine mount 10, the second attachment member 18 and the cup member 14 are mutually positioned in the axial direction (the vertical direction) by the rubber projection 44 and the inner surface of the engaging hole 60 catching on each other. This effectively prevents the axial misalignment of the second attachment member 18 and the cup member 14 caused by the elastic recovery force of the sealing rubber 40.

Besides, the press-fit tube part 32 of the second attachment member 18 is rubber press-fitted into the base press-fit part 58 of the cup member 14 via the press-fit rubber 42. Thus, the dislodging force caused by the elastic recovery force of the press-fit rubber 42, which has been deformed during the rubber press-fitting, also acts between the second attachment member 18 and the cup member 14. In the engine mount 10, the second attachment member 18 and the cup member 14 are mutually positioned in the axial direction by the rubber projection 44 and the inner surface of the engaging hole 60 being caught on each other. This prevents the axial misalignment of the second attachment member 18 and the cup member 14 caused by the elastic recovery force of the press-fit rubber 42.

Additionally, the rubber projection 44 is provided above the vertical center of the press-fit rubber 42. Thus, the axial length of the press-fit rubber 42 below the rubber projection 44 is set to be long, and the axial length of the rubber press-fit portion between the second attachment member 18 and the cup member 14 via the press-fit rubber 42 below the rubber projection 44 is sufficiently obtained. Therefore, the second attachment member 18 and the cup member 14 are more strongly held in position in the axial direction by the rubber press-fit. In the present practical embodiment in particular, the rubber projection 44 is provided at the upper end of the press-fit rubber 42. Thus, the axial length of the rubber press-fit portion by utilizing the press-fit rubber 42 is ensured to be longer, and the holding-in-position force due to the press-fit can be greatly obtained.

Furthermore, when the engine mount 10 is transported and the like in an isolated state without an outer bracket 102 described later mounted, even if the external force acts to separate the mount main body 12 and the cup member 14 in the vertical direction, the rubber projection 44 and the inner surface of the engaging hole 60 catch on each other to prevent separation of the mount main body 12 and the cup member 14 and to maintain the sealing performance in a more reliable manner. This facilitates the management of the engine mount 10 during storage, transportation, and the like.

In the present practical embodiment, as shown in FIG. 3, the rib-shaped parts 48 of the rubber projection 44 are pressed against the lower opening edge of the engaging hole 60, and the rubber projection 44 is urged upward by the elasticity of the rib-shaped parts 48. Therefore, the upper surface of the coupling part 46 of the rubber projection 44 is pressed against the inner surface of the engaging hole 60, and the mount main body 12 and the cup member 14 are positioned in the vertical direction. The mount main body 12 and the cup member 14 are also positioned in the left-right direction by the rib-shaped parts 48 being pressed against the opening peripheral edge of the engaging hole 60.

Besides, in the present practical embodiment, the rubber projection 44 is provided to the long-side portion of the second attachment member 18, and the engaging hole 60 into which the rubber projection 44 is inserted is formed on the long-side portion of the cup member 14, which has relatively low deformation rigidity in the radial direction. This allows the rubber projection 44 to be inserted into the engaging hole 60 while pushing open the base press-fit part 58 of the cup member 14 with relatively little force.

A partition member 64 and a flexible film 66 are arranged between the mount main body 12 and the cup member 14 assembled in this way, so as to constitute the engine mount 10. As shown in FIGS. 2 to 5, the partition member 64 has an approximately rounded rectangular plate shape overall, and has a structure in which a cover fitting 70 is overlapped and fixed to the upper surface of a partition member main body 68.

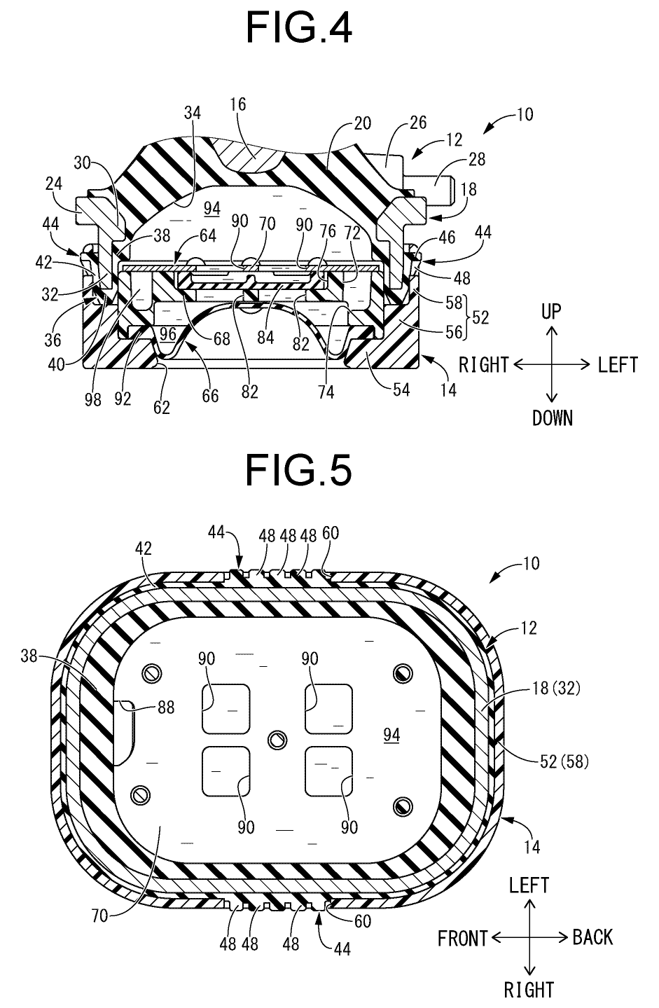

The partition member main body 68 has a thick-walled plate shape overall, and a circumferential groove 72 opens onto its upper surface so as to extend circumferentially in its outer peripheral portion. The circumferential groove 72 extends circumferentially for a length less than once around the circumference, and as shown in FIG. 4, a lower communication aperture 74 perforates its bottom wall portion at one circumferential end. On the radially inner side with respect to the circumferential groove 72, the partition member main body 68 includes a housing recess 76 opening onto its upper surface and a lightening recess 78 opening onto its lower surface. The central portion of the housing recess 76 includes a pillar-shaped central insertion part 80 protruding upward from the bottom wall. A plurality of lower through holes 82 perforate the bottom wall of the housing recess 76 in the vertical direction.

The housing recess 76 houses a movable film 84. The movable film 84 is made of a rubber elastic body, and has an approximately rounded quadrangular plate shape corresponding to the housing recess 76. The central portion of the movable film 84 is perforated by an insertion hole 86 in the vertical direction. With the movable film 84 housed in the housing recess 76, the central insertion part 80 of the partition member main body 68 is inserted through the insertion hole 86, so that the movable film 84 is positioned in the housing recess 76. The movable film 84 is thick-walled in the outer peripheral end and around the insertion hole 86, and is made thinner in the radially middle portion than the said portions.

The cover fitting 70 is overlapped on the upper surface of the partition member main body 68. The cover fitting 70 has a flat plate shape of a rounded quadrangle corresponding to the partition member main body 68 when viewed in the vertical direction, and is made of metal such as aluminum alloy and stainless steel, for example. As shown in FIG. 5, the cover fitting 70 includes an upper communication aperture 88 perforating its outer peripheral end in the vertical direction, and a plurality of upper through holes 90 perforating its radially inner portion in the vertical direction.

As shown in FIGS. 2 to 4, the cover fitting 70 is fixed to the partition member main body 68 in an overlapped state on the upper surface of the partition member main body 68, and the partition member 64 is constituted by including the partition member main body 68, the movable film 84, and the cover fitting 70. By the cover fitting 70 being overlapped on the partition member main body 68, the upper opening of the circumferential groove 72 is covered by the cover fitting 70 to form a tunnel-like passage. Besides, the upper opening of the housing recess 76 is covered by the cover fitting 70 to form a space, and the movable film 84 is housed within the said space. Regarding the movable film 84, the radially inner end and the outer peripheral end, which are thick-walled, are vertically compressed between the bottom wall of the housing recess 76 of the partition member main body 68 and the cover fitting 70, while the upper surface of the radially middle portion, which is thin-walled, is spaced apart downward from the cover fitting 70.

Regarding the partition member 64, the upper part is inserted in the press-fit tube part 32 of the second attachment member 18 of the mount main body 12, while the lower part is inserted in the partition insertion part 56 of the cup member 14, so that the partition member 64 is arranged so as to spread in the direction orthogonal to the vertical direction between the mount main body 12 and the cup member 14. In the present practical embodiment, the outer circumferential surface of the partition member main body 68 is fitted to the press-fit tube part 32 of the second attachment member 18 via the inner circumferential rubber 38 while being fitted to the partition insertion part 56 of the cup member 14, thereby positioning the partition member 64 with respect to the mount main body 12 and the cup member 14. The partition member 64 is positioned in relation to the mount main body 12 and the cup member 14. As shown in an enlarged view in FIG. 3, in the isolated state of the engine mount 10 before the outer bracket 102 is mounted, the outer circumferential end of the cover fitting 70 is spaced apart downward from the portion of the inner circumferential rubber 38 that covers the lower surface of the bonding part 30.

The flexible film 66 is disposed below the partition member 64. The flexible film 66 is made of rubber or resin elastomer, has a thin dome shape, and is flexible to allow deformation in the thickness direction. An annular holding part 92 that is relatively thick-walled is provided at the outer peripheral end of the flexible film 66. By the holding part 92 being vertically clasped between the partition member main body 68 and the bottom wall 54 of the cup member 14 about the entire circumference, the flexible film 66 is arranged so as to cover the lower side of the partition member 64. The radially inner portion of the flexible film 66, which is thin-walled, is exposed downward through the passage hole 62 of the bottom wall 54 of the cup member 14, and the flexible film 66 is allowed to deform so as to expand downward by the passage hole 62.

A pressure-receiving chamber 94 serving as a fluid chamber whose wall is partially constituted by the main rubber elastic body 20 and which gives rise to internal pressure fluctuations during input of vibration is formed between the mount main body 12 and the partition member 64. Besides, an equilibrium chamber 96 serving as a fluid chamber whose wall is partially constituted by the flexible film 66 and which permits changes in volume is formed between the partition member 64 and the flexible film 66. The pressure-receiving chamber 94 and the equilibrium chamber 96 are filled with a non-compressible fluid or liquid comprising, for example, water, ethylene glycol, alkylene glycol, silicone oil, a mixture of these, or the like. In the engine mount 10, the rubber layer 36 including the sealing rubber 40 provides a sealing between the mount main body 12 and the cup member 14, and the holding part 92 of the flexible film 66 provides a sealing between the cup member 14 and the partition member 64 to prevent leakage of the non-compressible fluid sealed inside.

The circumferential groove 72 of the partition member 64 communicates with the pressure-receiving chamber 94 through the upper communication aperture 88, and communicates with the equilibrium chamber 96 through the lower communication aperture 74. The circumferential groove 72 and the upper and lower communication apertures 88, 74 form an orifice passage 98 that interconnects the pressure-receiving chamber 94 and the equilibrium chamber 96. The tuning frequency of the orifice passage 98, which is the resonance frequency of the flowing fluid, is set to the frequency of the vibration to be damped, for example, the frequency of low-frequency vibration such as engine shake.

Regarding the movable film 84 of the partition member 64, its upper surface receives the liquid pressure of the pressure-receiving chamber 94 through the upper through hole 90, while its lower surface receives the liquid pressure of the equilibrium chamber 96 through the lower through hole 82. When relative pressure fluctuations arise between the pressure-receiving chamber 94 and the equilibrium chamber 96, the radially middle portion of the movable film 84 deforms in the vertical direction such that the movable film 84 functions to transmit the liquid pressure between the pressure-receiving chamber 94 and the equilibrium chamber 96 to each other.

Meanwhile, as shown in FIGS. 14 to 19, an inner bracket 100 and an outer bracket 102 are attached to the engine mount 10. The inner bracket 100 has a thick-walled plate shape extending in the left-right direction overall. In the present practical embodiment, its right end is the portion attached to the first attachment member 16, while its left end is the portion to be attached to the power unit of the vehicle. The right end of the inner bracket 100 of the present practical embodiment is fixed to the first attachment member 16 by a bolt 104 screwed into a screw hole 22. The left end of the inner bracket 100, which is to be attached to the power unit, is widened in the front-back direction, and is perforated by a plurality of first fastening holes 106 in the vertical direction. The inner bracket 100 is preferably made of metal such as iron, for example, and is a high rigidity component.

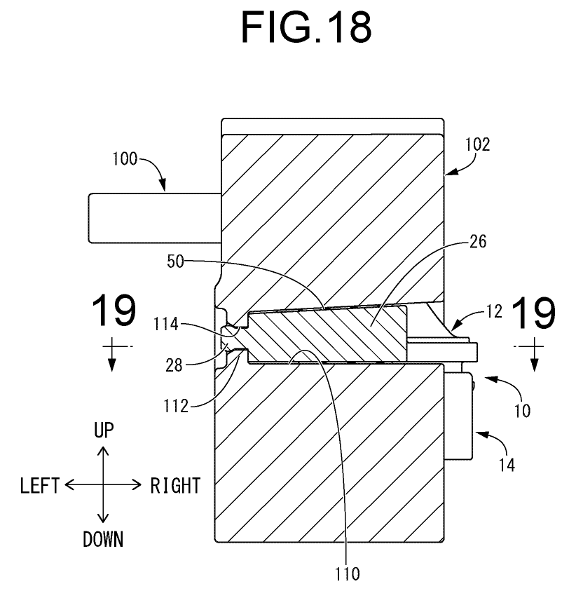

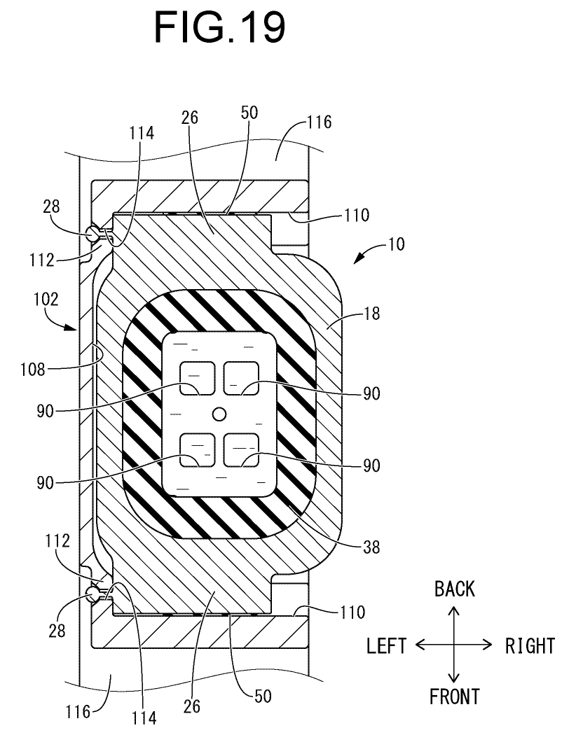

The outer bracket 102 includes a mount housing space 108 into which the engine mount 10 is attached in an inserted state. The mount housing space 108 has a recess shape opening rightward, and includes a pair of fitting grooves 110, 110 opening onto the wall inner surfaces on the opposite sides in the front-back direction. As shown in FIG. 18, each fitting groove 110 extends straightly in the left-right direction, and in the present practical embodiment, its vertical dimension increases rightward. Besides, the fitting groove 110 reaches the right end of the outer bracket 102 and is open rightward, but does not reach the left end, and a far wall 112 is provided on the left side of the fitting groove 110. A pin insertion hole 114 corresponding to the swaging pin 28 of the second attachment member 18 perforates the far wall 112 in the left-right direction.

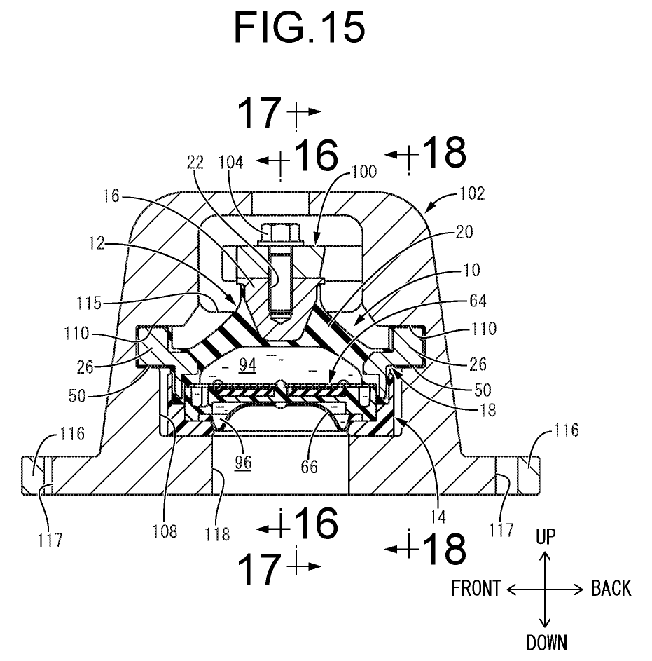

As shown in FIG. 17, the left wall of the mount housing space 108 of the outer bracket 102 includes a window 115 perforating the upper part in the left-right direction. The outer bracket 102 includes a pair of attachment pieces 116, 116 protruding from the lower end to the opposite sides in the front-back direction. As shown in FIGS. 14 and 15, each attachment piece 116 is perforated by a second fastening hole 117 in the vertical direction. As shown in FIGS. 15 to 17, the lower wall of the mount housing space 108 of the outer bracket 102 is perforated by an open hole 118 in the vertical direction, and the flexible film 66 is allowed to deform downward by the open hole 118.

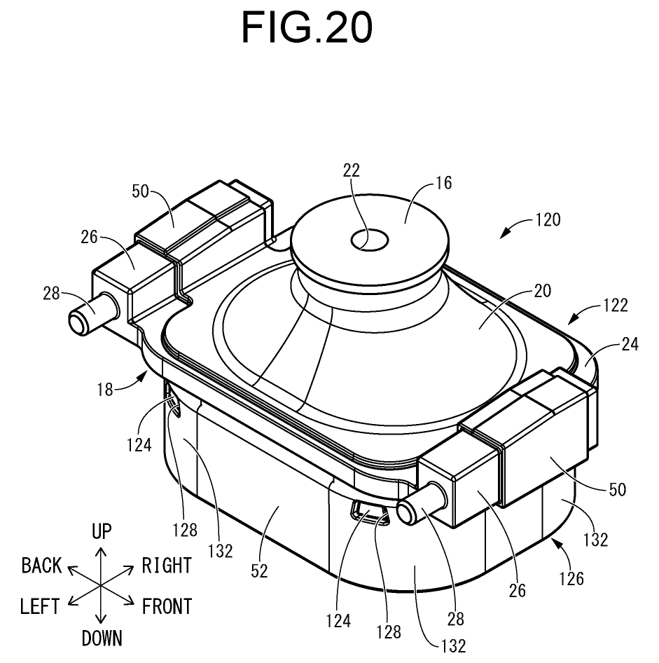

The outer bracket 102 is mounted onto the second attachment member 18 side of the engine mount 10. Specifically, as shown in FIGS. 18 and 19, the front and back fitting parts 26, 26 of the second attachment member 18 are fitted into the front and back fitting grooves 110, 110 of the mount housing space 108 of the outer bracket 102, and the lower surface of the cup member 14 coupled to the second attachment member 18 is overlapped on the upper surface of the lower wall of the mount housing space 108, so that the outer bracket 102 is attached to the second attachment member 18 side of the engine mount 10. In mounting the outer bracket 102 onto the engine mount 10, the mount main body 12 and the cup member 14 are mutually positioned by the outer bracket 102.

As shown in FIG. 18, the vertical dimension of the fitting groove 110 gradually increases rightward. The fitting part 26 is inserted from the right end opening of the fitting groove 110 toward the left side, which facilitates the insertion of the fitting part 26 into the fitting groove 110. As shown in FIG. 18, the fitting part 26 has the vertical dimension smaller than that of the fitting groove 110, and is not clasped between the upper and lower inner surfaces of the fitting groove 110. The upper and lower inner surfaces of the fitting groove 110 and the upper and lower outer surfaces of the fitting part 26 are in indirect contact via the fitting rubber 50 bonded to the surface of the fitting part 26. Besides, as shown in FIG. 19, the outer surfaces in the front-back direction of the fitting parts 26 are in indirect contact with the inner surfaces in the front-back direction of the fitting grooves 110 via the fitting rubbers 50. That is, the fitting parts 26 are in a rubber press-fitted state of being fitted to the fitting grooves 110 via the fitting rubbers 50.

As shown in FIGS. 18 and 19, with the fitting part 26 fitted to the fitting groove 110, the swaging pin 28 protruding from the left end surface of the fitting part 26 is inserted through the pin insertion hole 114 formed in the far wall 112 of the fitting groove 110. By applying compression force in the axial direction (the left-right direction) to the swaging pin 28 inserted in the pin insertion hole 114 to crush the distal end portion of the swaging pin 28, the distal end portion of the swaging pin 28 deforms to be enlarged in diameter, thereby being fixed by swaging to the inner circumferential surface of the opening portion of the pin insertion hole 114. This prevents rightward displacement of the fitting part 26 with respect to the outer bracket 102, which prevents rightward dislodgment of the fitting part 26 from the fitting groove 110, thereby preventing separation of the engine mount 10 and the outer bracket 102.

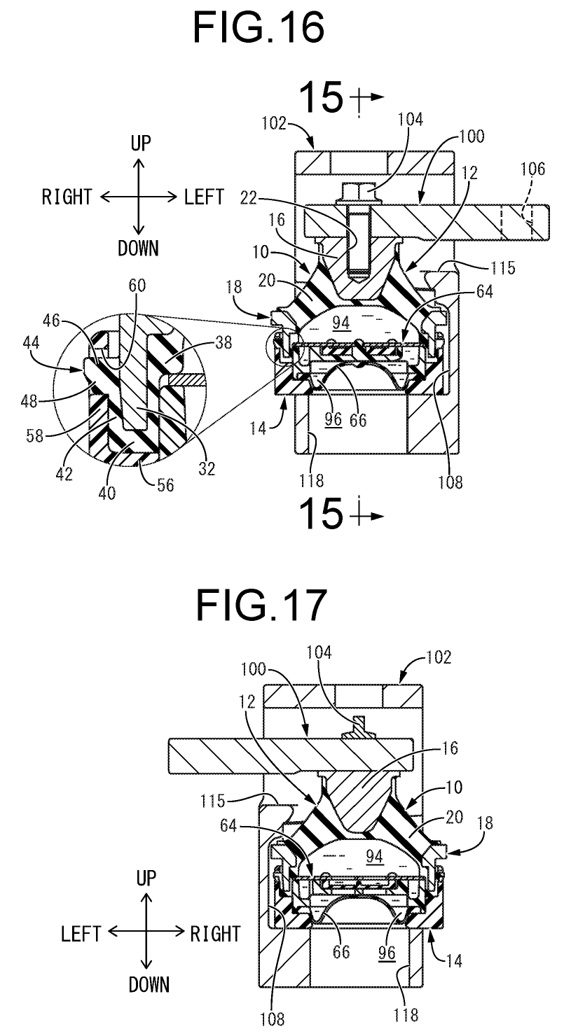

With the outer bracket 102 mounted on the engine mount 10, as shown in FIGS. 16 and 17, regarding the inner bracket 100 fixed to the first attachment member 16, its left end, which is the portion to be attached to the power unit, protrudes leftward with respect to the outer bracket 102 through the window 115 of the outer bracket 102.

As shown in FIGS. 15 to 17, by the outer bracket 102 being mounted onto the engine mount 10, the mount main body 12 and the cup member 14 become closer to each other in the vertical direction than in the isolated state of the engine mount 10. By so doing, the press-fit tube part 32 of the second attachment member 18 and the upper surface of the partition insertion part 56 of the cup member 14 become close to each other, and the sealing rubber 40 is compressed more greatly between the press-fit tube part 32 and the upper surface of the partition insertion part 56. This achieves improvement in the sealing performance by means of the sealing rubber 40 between the second attachment member 18 and the cup member 14.

Besides, as shown in an enlarged view in FIG. 16, by the outer bracket 102 being mounted onto the engine mount 10, the inner circumferential rubber 38, which covers the lower surface of the bonding part 30 of the second attachment member 18, is liquid-tightly pressed against the upper surface of the partition member 64, thereby preventing a short circuit between the pressure-receiving chamber 94 and the equilibrium chamber 96 via the outer peripheral side of the partition member 64. By the bonding part 30 being pressed against the partition member 64 via the inner circumferential rubber 38, the holding part 92 of the flexible film 66 is more strongly clasped between the lower surface of the partition member 64 and the bottom wall 54 of the cup member 14, thereby improving the sealing performance by means of the holding part 92 as well.

As described above, the engine mount 10 in isolation without the outer bracket 102 mounted is in a temporary sealed state in which the sealing performance is ensured to the extent that the non-compressible fluid does not leak to the outside. By the outer bracket 102 being mounted onto the engine mount 10, the sealing performance is improved, and the engine mount 10 achieves a full sealed state in which the short circuit between the pressure-receiving chamber 94 and the equilibrium chamber 96 or the like is prevented.

As shown in FIG. 16, with the outer bracket 102 mounted on the engine mount 10, the rubber projections 44 are spaced apart downward from the upper inner surface of the engaging hole 60 of the cup member 14, but the mount main body 12 and the cup member 14 are vertically positioned by the outer bracket 102 to be prevented from separation.

The engine mount 10 is mounted and used on a vehicle by the first attachment member 16 being attached to the power unit side via the inner bracket 100 while the second attachment member 18 being attached to the vehicle body side via the outer bracket 102. When vertical vibration is input across the first attachment member 16 and the second attachment member 18, vibration damping effect based on flow action of the fluid and the like is exhibited. Specifically, when low-frequency vibration corresponding to engine shake is input, the relative pressure fluctuations between the pressure-receiving chamber 94 and the equilibrium chamber 96 causes the fluid flow between the two chambers 94, 96 through the orifice passage 98, and vibration damping effect (high attenuating effect) based on the flow action of the fluid is exhibited. Besides, when medium- to high-frequency vibration such as idling vibration and booming noise is input, the liquid pressure transmission between the two chambers 94, 96 due to deformation of the movable film 84 avoids high dynamic spring behavior due to a substantial sealing of the pressure-receiving chamber 94, and vibration damping effect (vibration isolation effect) due to the low dynamic spring is exhibited.

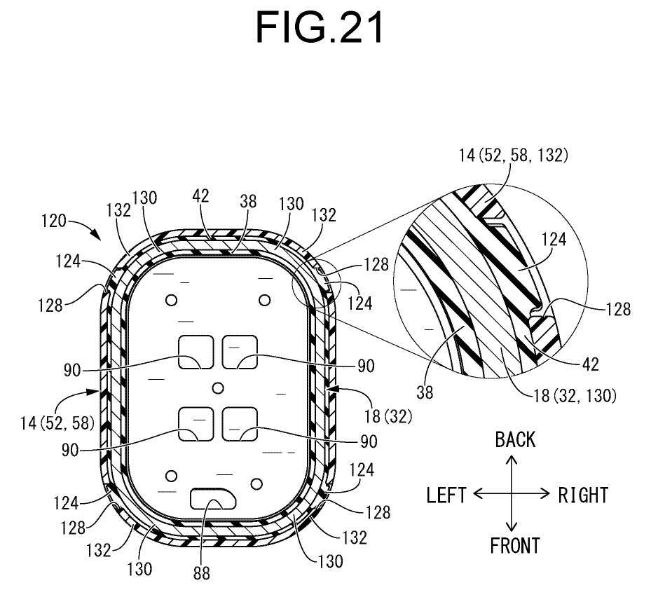

FIGS. 20 and 21 depict an automotive engine mount 120 as a second practical embodiment of the fluid-filled vibration damping device constructed according to the present disclosure. In the following description, components and parts that are substantially identical with those in the first practical embodiment will be assigned like symbols and not described in any detail.

The engine mount 120 includes rubber projections 124 serving as engaging rubbers protruding radially outward from the press-fit rubber 42 of a mount main body 122. By the rubber projections 124 being inserted in the axis-perpendicular direction into engaging holes 128 formed in the peripheral wall 52 of a cup member 126, the mount main body 122 is prevented from becoming dislodged from the cup member 126.

The rubber projections 124 protrude outward in the left-right direction at corners 130 of the second attachment member 18, which has an approximately rounded quadrangular tube shape, and are separately provided at four locations in the circumferential direction. Each corner 130 of the second attachment member 18 is curved arcuately when viewed in the vertical direction. Each rubber projection 124 of the present practical embodiment has an approximately quadrangular pillar shape, and the outer circumferential surface, which is the protruding distal end surface, comprises a curved surface corresponding to the outer circumferential surface of the cup member 126. The rubber projection 124 has the outer dimensions in the vertical direction and in the left-right direction that are smaller than the inner dimensions of the engaging hole 128 in the vertical direction and in the left-right direction.

The engaging holes 128 are separately formed in curved corners 132 of the peripheral wall 52 (the base press-fit part 58) of the cup member 126, which has an approximately rounded quadrangular tube shape, and perforate the peripheral wall 52 in the left-right direction at four locations in the circumferential direction. Like the corner 130 of the second attachment member 18, each curved corner 132 is curved arcuately when viewed in the vertical direction. The engaging hole 128 of the present practical embodiment has a cross-sectional shape of a generally unchanging quadrangle.

The lower end of the mount main body 122 is rubber press-fitted into the base press-fit part 58 of the cup member 126 via the press-fit rubber 42, so that the mount main body 122 and the cup member 126 are coupled to each other.

Besides, each rubber projection 124 provided to the mount main body 122 is inserted into the corresponding engaging hole 128 provided to the cup member 126, and the upper surface of the rubber projection 124 is overlapped with the upper inner surface of the engaging hole 128. This limits the upward displacement of the mount main body 122 relative to the cup member 126, and the mount main body 122 and the cup member 126 are mutually positioned in the vertical direction to prevent separation due to dislodgment.

In the present practical embodiment, the rubber projections 124 provided to the four corners 130, 130, 130, 130 of the second attachment member 18 are inserted into the respective engaging holes 128 provided to the four curved corners 132, 132, 132, 132 of the cup member 126 to be engaged in the vertical direction. The corner 130 of the second attachment member 18 and the curved corner 132 of the cup member 126 both have transverse cross sections that are arcuately curved, so that they have a high shape stability and are less likely to deform. Therefore, the engaged state of the rubber projection 124 and the engaging hole 128 is stabilized, thereby more effectively preventing separation of the mount main body 122 and the cup member 126 involving release of the engaged state.

Moreover, the retaining structure by means of engagement between the rubber projection 124 and the engaging hole 128 is provided at four locations in the circumferential direction. Thus, in comparison with the case where the retaining structure is provided at only two locations on the opposite side portions, the retaining action can be more greatly obtained.

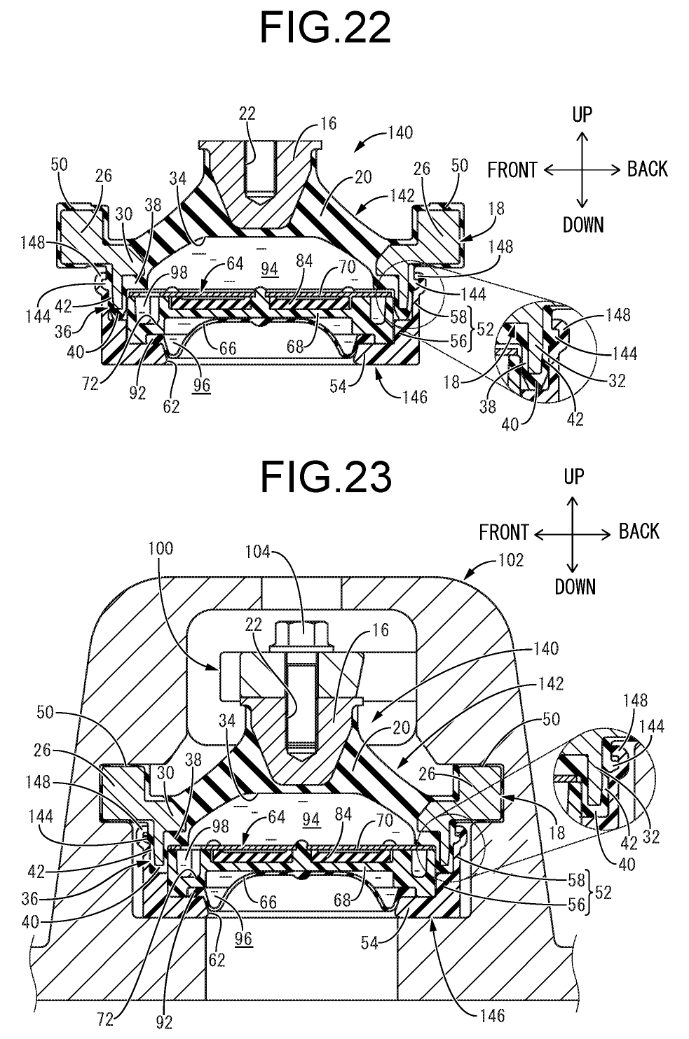

FIG. 22 depicts an automotive engine mount 140 as a third practical embodiment of the fluid-filled vibration damping device constructed according to the present disclosure. The engine mount 140 includes a mount main body 142, and rubber projections 144 serving as engaging rubbers and protruding radially outward from the press-fit rubber 42 of the mount main body 142. By hooks 148 provided to a cup member 146 being hooked on and axially engaged with the rubber projections 144, the mount main body 142 and the cup member 146 are positioned in the axial direction, thereby preventing the mount main body 142 from becoming dislodged from the cup member 146.

The rubber projections 144 of the present practical embodiment protrude from the short-side portions of the second attachment member 18. In each rubber projection 144, the upper surface spreads approximately orthogonal to the vertical direction, while the lower surface comprises a sloping surface that slopes upward toward the protruding distal end (outward in the front-back direction).

Each hook 148 protrudes upward (toward the proximal end side of insertion of the mount main body 142 into the cup member 146) from the base press-fit part 58 of the cup member 146, and has a concave shape opening inward in the front-back direction when viewed in the vertical cross section shown in FIG. 22. One hook 148 is provided to each of the pair of short-side portions of the cup member 146. Since the hook 148 is provided partially in the circumferential direction, the hook 148 has the deformation rigidity lower than that of the base press-fit part 58, which is tubular, so that deformation, such as tilting outward in the front-back direction, for example, can occur with relatively small input.

The lower end of the mount main body 142 is rubber press-fitted into the base press-fit part 58 of the cup member 146 via the press-fit rubber 42, so that the mount main body 142 and the cup member 146 are coupled to each other.

The hooks 148 provided to the cup member 146 are hooked on the respective rubber projections 144 provided to the mount main body 142, and the upper surface of each rubber projection 144 is vertically overlapped with the corresponding hook 148. This axial engagement between the rubber projection 144 and the hook 148 in this way limits the upward displacement of the mount main body 142 relative to the cup member 146, and the mount main body 142 and the cup member 146 are mutually positioned in the vertical direction to prevent separation due to dislodgment.

In the present practical embodiment, the engaging portion of the cup member 146 side that engages with the rubber projection 144 comprises the hook 148. The hook 148 protrudes upward from the peripheral wall 52 of the cup member 146 and is partially provided along the circumference. Thus, when the rubber projection 144 passes over the upper part of the hook 148, the hook 148 is relatively easily pushed to be wider radially outward and opens to the radially outer side. This makes it easy to hook and engage the hook 148 against the rubber projection 144, thereby facilitating the coupling operation between the mount main body 142 and the cup member 146.

The hook 148 is provided to the short-side portion of the peripheral wall 52 of the cup member 146, which has the deformation rigidity higher than that of the long-side portion. This prevents the hook 148 from becoming excessively easy to open due to deformation of the peripheral wall 52 of the cup member 146, and the engaged state between the rubber projection 144 and the hook 148 is stably held.

As shown in FIG. 23, with the outer bracket 102 mounted on the engine mount 140, the hook 148 is spaced apart from the upper surface of the rubber projection 144, and the engagement between the hook 148 and the rubber projection 144 is released. However, the second attachment member 18 and the cup member 146 are mutually held in position in the vertical direction by the outer bracket 102, whereby separation of the mount main body 142 and the cup member 146 is avoided.

While the present disclosure has been described in detail hereinabove in terms of the practical embodiments, the disclosure is not limited by the specific description thereof. For example, the rubber projections 44 and the engaging holes 60 may be formed on both the long-side portion and the short-side portion, or two of them may be provided to one long-side portion or one short-side portion. Similarly, the number and arrangement of the hooks 148 are not limited.

The preceding first practical embodiment exemplified the following structure. Specifically, the engine mount 10 in isolation with the mount main body 12 and the cup member 14 coupled is in a temporary sealed state whose sealing performance is at a level that can prevent the liquid leakage to the outside, and when the outer bracket 102 is mounted onto the engine mount 10, the engine mount 10 achieves a full sealed state for use. However, for example, it would also be possible to set the amount of compressive deformation of the sealing rubber 40 or the like so that the engine mount 10 is in the full sealed state in isolation.

The first practical embodiment exemplified the rubber projection 44 serving as the engaging rubber that protrudes radially outward with respect to the press-fit rubber. However, for example, it would also be acceptable to provide the outer circumferential surface of the press-fit rubber 42 with a step that is continuous partially in the circumferential direction or about the entire circumference, so that the hook 148 on the cup member 14 side is hooked on and engaged with the said step. In this case, the engaging rubber is constituted by the step portion of the press-fit rubber 42.

The shapes of the second attachment member 18 and the cup member 14 are not necessarily limited to the rounded quadrangles when viewed in the vertical direction, but for example, they may be circular, elliptical, or the like in the vertical direction.

What is claimed is:

1. A fluid-filled vibration damping device comprising:
a first attachment member;
a second attachment member having an annular shape;
a main rubber elastic body connecting the first attachment member and the second attachment member;
a fluid chamber filled with a non-compressible fluid; and
a cup member in which the second attachment member is rubber press-fitted via a press-fit rubber provided to an outer circumferential surface of the second attachment member, wherein
a sealing rubber is provided to a distal end surface of insertion of the second attachment member into the cup member, and the sealing rubber provides a sealing axially between the distal end surface of the second attachment member and the cup member,
an engaging rubber integrally formed with the press-fit rubber is provided to the outer circumferential surface of the second attachment member, and the second attachment member and the cup member are mutually positioned in an axial direction by engagement between the engaging rubber and the cup member.

2. The fluid-filled vibration damping device according to claim 1, wherein
the engaging rubber comprises a rubber projection protruding radially outward with respect to the press-fit rubber, and
the rubber projection is inserted in an axis-perpendicular direction into an engaging hole perforating a peripheral wall of the cup member, and the rubber projection is engaged with an inner circumferential surface of the engaging hole of the cup member in the axial direction.

3. The fluid-filled vibration damping device according to claim 2, wherein
the second attachment member has a flat annular shape with a long side and a short side when viewed in the axial direction, and
the rubber projection is provided to a long-side portion of the second attachment member.

4. The fluid-filled vibration damping device according to claim 2, wherein
the second attachment member has a flat annular shape with a long side and a short side when viewed in the axial direction, and
the rubber projection is provided to a corner of the second attachment member.

5. The fluid-filled vibration damping device according to claim 1, wherein
the cup member includes a hook protruding from a peripheral wall toward a proximal end side of insertion of the second attachment member, and the hook is engaged with the engaging rubber in the axial direction.

6. The fluid-filled vibration damping device according to claim 5, wherein
the cup member has a flat annular shape with a long side and a short side when viewed in the axial direction, and
the hook is provided to a short-side portion of the cup member.

7. The fluid-filled vibration damping device according to claim 1, wherein
the engaging rubber protrudes radially outward with respect to the press-fit rubber, and
in a direction of insertion of the second attachment member, the engaging rubber is located on a proximal end side of the insertion with respect to a center of the press-fit rubber.
